(19) United States
(12) Patent Application Publication
(10) Pub. No.: US 2022/0335585 A1
(43) Pub. Date: Oct. 20, 2022

(54) SET UP OF A VISUAL INSPECTION PROCESS

(71) Applicant: INSPEKTO A.M.V. LTD., RAMAT GAN (IL)

(72) Inventors: ALEXANDER SPIVAK, HADERA (IL); YONATAN HYATT, TEL-AVIV (IL); RAN GINSBURG, RAMAT GAN (IL)

(21) Appl. No.: 17/620,759

(22) PCT Filed: Jun. 20, 2020
(86) PCT No.: PCT/IL2020/050688

§ 371 Date: Dec. 20, 2021

Related U.S. Application Data
(60) Provisional application No. 62/863,924, filed on Jun. 20, 2019.

(30) Foreign Application Priority Data
Jun. 20, 2019 (IL) 267563

(51) Int. Cl. G06T 7/00; G06F 3/04842; G06T 7/73

(52) U.S. Cl. CPC G06T 7/001; G06F 3/04842; G06T 7/74; G06T 2200/24; G06T 2207/30164

(57) ABSTRACT

A visual inspection process which includes receiving a plurality of reference images, each of the reference images including a same-type item on an inspection line, comparing the reference images to each other and displaying to a user a status of the visual inspection process based on the comparison of the reference images to each other.

### FIELD

The present invention relates to automated visual inspection processes, for example, inspection of items during a production process.

### BACKGROUND

Inspection during production processes helps control the quality of products by identifying defects and acting upon their detection, for example, by fixing them or discarding the defected part, and is thus useful in improving productivity, reducing defect rates, and reducing re-work and waste.

Automated visual inspection methods are used in production lines to identify visually detectable anomalies that may have a functional or esthetical impact on the integrity of a manufactured part. Existing visual inspection solutions for production lines on the market today rely on custom made automated visual inspection systems, which are typically highly expensive and require expert integration of hardware and software components. Setting up these systems, which may include obtaining images to be used by the system as references for defect detection and other inspection tasks, is typically complex and can be done by experts only. Additionally, the system must be set up for each new manufactured article or new identified defect, which causes downtime that may be measured in months. During the downtime period, a plant is compelled to use expensive internal/external human workforce to perform quality assurance (QA), gating, sorting or other tasks, or bear the risk of production degrade.

There is a growing inconsistency between industrial plants' need for agility and improvement, on one hand, and the cumbersome and expensive set up process of contemporary inspection solutions, on the other hand.

### SUMMARY

Embodiments of the invention provide a system and method for communicating with a user during a visual inspection process to shorten set up time and to keep the user informed regarding the progress of the visual inspection process.

In one embodiment, during a set up stage of a visual inspection process, samples of a manufactured item with no defects (defect free items) are imaged on an inspection line, the same inspection line or an inspection line having similar set up parameters to those being used for the inspection stage. The images are analyzed by a processor and are then used as reference images for machine learning algorithms run at the inspection stage.

In embodiments of the invention, a status of a set up process is displayed to the user. Keeping the user informed of the status of the visual inspection process, throughout the process, avoids frustration and enables the user to plan his time efficiently.

The user may provide feedback (e.g., confirmation or correction) based on the displayed information. Enabling corrections or other feedback from the user during the set up and/or inspection process (as opposed to waiting until the end of the analysis of all the images before enabling the user to introduce corrections and then waiting again for analysis of the corrected information) greatly shortens the set up and inspection processes.

Additional embodiments of the invention provide an improved user interface for a visual inspection process, facilitating the user's understanding of the status of the processes, enabling the user to react more efficiently, thereby greatly streamlining the visual inspection process.

### BRIEF DESCRIPTION OF THE FIGURES

The invention will now be described in relation to certain examples and embodiments with reference to the following illustrative figures so that it may be more fully understood. In the drawings:

FIG. 1 is a schematic illustration of a system for visual inspection, according to an embodiment of the invention;

FIGS. 2A and 2B schematically illustrate a method and user interface for displaying status of a set up process, according to embodiments of the invention;

FIGS. 3A and 3B schematically illustrate a method for updating a reference image database, according to embodiments of the invention;

FIGS. 4A and 4B schematically illustrate a method for displaying an image with a defected item, according to embodiments of the invention;

FIGS. 5A and 5B schematically illustrate a method for displaying an image with an unknown positioning of an item, according to embodiments of the invention;

FIG. 6 schematically illustrates a method for displaying a status of a set up process, according to an embodiment of the invention; and

FIGS. 7, 8 and 9 schematically illustrate user interfaces for assisting a user, according to embodiments of the invention.

### DETAILED DESCRIPTION

Typically, a visual inspection process uses images of items confirmed by a user, as a reference to which unconfirmed images of same-type items are compared, to detect defects on the item in the unconfirmed image and/or for other inspection tasks, such as QA, sorting, gating and more. The user confirmed images are referred to as “reference images”. Reference images obtained during a set up stage of the visual inspection process may also be referred to as “set up images”.

Typically, a visual inspection process includes an inspection stage following an initial set up stage. In the inspection stage, inspected items (manufactured items that are to be analyzed for inspection tasks, e.g., defect detection, QA, sorting and/or counting, etc.) are imaged and inspection tasks can be performed on the inspected items based on analysis of the set up images and inspection images.

In some embodiments, a set up stage may occur during the inspection stage as well as prior to the inspection stage, as further detailed below.

In one embodiment, in the set up stage, samples of a manufactured item with no defects (defect-free items) are imaged on an inspection line. In other embodiments samples of a manufactured item with a defect may be imaged on the inspection line, during the set up stage. These set up images are analyzed by a processor and are then used as reference images for image processing and defect detection algorithms run at the inspection stage.

Reference images (which are user-confirmed images) are not used for detecting defects on items imaged in them (or for other inspection tasks), as opposed to inspection images that are used for inspection tasks to be performed on them during inspection. Reference images may be obtained during an initial set up stage, prior to an inspection stage and/or during the inspection stage. For example, when a user confirms an inspection image (e.g., the user confirms that the imaged item is defected/defect free and/or confirms that the item is correctly positioned) the user-confirmed image may then be used as a reference image.

In some embodiments, during the set up stage, a processor learns spatial properties and uniquely representing features or attributes of an item in reference images, as well as optimal parameters of reference images, for example, optimal imaging parameters (e.g., exposure time, focus and illumination). These properties may be learned, for example, by analyzing images of an item (e.g., a defect-free item) using different imaging parameters and by analyzing the relation between different images of a same type of (defect-free) item. This analysis during the set up stage enables to discriminatively detect a same type of item (either defect free or with a defect) in a new image, regardless of the imaging environment of the new image, and enables to continually optimize the imaging parameters with minimal processing time during the following inspection stage.

In one embodiment, the analysis of reference images is used to determine a spatial range in which an item shows no perspective distortion. The level of perspective distortion between items in different images can be analyzed, for example, by detecting regions in an item which do not have corresponding features between the reference images, by analyzing the intersection location and angles between the item's borders or marked areas of interest on the item, etc. The borders of the spatial range may be calculated by comparing two (or more) reference images (in which items may be positioned and/or oriented differently) and determining which of the images show perspective distortion and which do not.

The calculated range can then be used to determine the borders of where and/or in which orientation, scale or other dispositioning, an inspected item may be placed on the inspection line so as to avoid distortion. Additionally, by using a set of reference images as references for each other, the processor can detect images having similar spatial decomposition and this set of images can then be analyzed to see if there are enough similar reference images to allow registration, defect-detection and other analyses for each possible positioning of the item on the inspection line.

“Enough reference images” are collected when an essentially complete representation of a type of item is achieved. For example, an essentially complete representation of an item may be achieved when enough images are collected to enable determining the spatial range in which each reference image of the item can be used as a distortion-less reference, as described above. Analysis of the reference images may be performed to collect information regarding possible 2D shapes and 3D characteristics (e.g., rotations on the inspection line) of an item or to find uniquely discriminative features of the item and the spatial relation between these unique features, as preserved between the reference images.

Based on the information collected from set up images, a processor can detect a second item of the same type and perform inspection tasks, even if the second item was not previously learned by the processor. This allows the processor to detect when a new item (of the same type) is imaged, and then to analyze the new item, for example, to search for a defect on an inspected item, based on the analysis of set up images.

Although a particular example of a set up procedure or stage of a visual inspection process is described herein, it should be appreciated that embodiments of the invention may be practiced with other set up procedures of visual inspection processes.

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “analyzing”, “processing,” “computing,” “calculating,” “determining,” “detecting”, “identifying”, “creating”, “producing”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Unless otherwise stated, these terms refer to automatic action of a processor, independent of and without any actions of a human operator.

The terms “item” and “object” may be used interchangeably and are meant to describe the same thing.

The term “same-type items” or “same-type objects” refers to items or objects which are of the same physical makeup and are similar to each other in shape and dimensions and possibly color and other physical features. Typically, items of a single production series, batch of same-type items or batch of items in the same stage in its production line, may be “same-type items”. For example, if the inspected items are sanitary products, different sink bowls of the same batch are same-type items.

A defect may include, for example, a visible flaw on the surface of the item, an undesirable size of the item or part of the item, an undesirable shape or color of the item or part of the item, an undesirable number of parts of the item, a wrong or missing assembly of interfaces of the item, a broken or burned part, and an incorrect alignment of the item or parts of the item, a wrong or defected barcode, serial number, text, icon, etc., and in general, any difference between the defect-free sample and the inspected item, which would be evident from the images to a user, namely, a human inspector. In some embodiments a defect may include flaws which are visible only in enlarged or high resolution images, e.g., images obtained by microscopes or other specialized cameras.

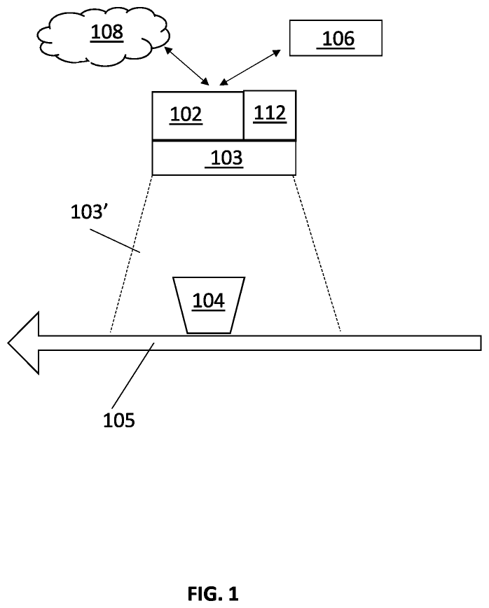

Methods according to embodiments of the invention may be performed by a system for visual inspection, an example of which is schematically illustrated in FIG. 1.

An exemplary system which may be used for automated visual inspection of an item on an inspection line, includes a processor 102 in communication with one or more camera(s) 103 and with a device, such as a user interface device 106 and/or other devices, such as storage device 108.

Components of the system may be in wired or wireless communication and may include suitable ports and/or network hubs. In some embodiments processor 102 may communicate with a device, such as storage device 108 and/or user interface device 106 via a controller, such as a programmable logic controller (PLC), typically used in manufacturing processes, e.g., for data handling, storage, processing power, and communication capabilities. A controller may be in communication with processor 102, storage device 108, user interface device 106 and/or other components of the system, via USB, Ethernet, appropriate cabling, etc.

Processor 102 may include, for example, one or more processors and may be a central processing unit (CPU), a graphics processing unit (GPU), a digital signal processor (DSP), a field-programmable gate array (FPGA), a microprocessor, a controller, a chip, a microchip, an integrated circuit (IC), or any other suitable multi-purpose or specific processor or controller. Processor 102 may be locally embedded or remote.

The user interface device 106 may include a display, such as a monitor or screen, for displaying images, instructions and/or notifications to a user (e.g., via text or other content displayed on the monitor). User interface device 106 may also be designed to receive input from a user. For example, user interface device 106 may include a monitor and keyboard and/or mouse and/or touch screen, to enable a user to input feedback.

Storage device 108 may be a server including for example, volatile and/or non-volatile storage media, such as a hard disk drive (HDD) or solid-state drive (SSD). Storage device 108 may be connected locally or remotely, e.g., in the cloud. In some embodiments, storage device 108 may include software to receive and manage image data related to reference images. A reference image database may be located at storage device 108 or at another location. The reference image database may store the reference images and information regarding the reference images, e.g., groups or clusters of images (further described below).

Camera(s) 103, which are configured to obtain an image of an inspection line 105, are typically placed and fixed in relation to the inspection line 105 (e.g., a conveyer belt), such that items (e.g., item 104) placed on the inspection line 105 are within the field of view (FOV) 103′ of the camera 103.

Camera 103 may include a CCD or CMOS or other appropriate chip. The camera 103 may be a 2D or 3D camera. In some embodiments the camera 103 may include a standard camera provided, for example, with mobile devices such as smart-phones or tablets. In other embodiments the camera 103 is a specialized camera, e.g., a camera for obtaining high resolution images.

The system may also include a light source, such as an LED or other appropriate light source, to illuminate the camera FOV 103′, e.g., to illuminate item 104 on the inspection line 105.

Processor 102 receives image data (which may include data such as pixel values that represent the intensity of reflected light as well as partial or full images or videos) of objects on the inspection line 105 from the one or more camera(s) 103 and runs processes according to embodiments of the invention.

Processor 102 is typically in communication with a memory unit 112. Memory unit 112 may store at least part of the image data received from camera(s) 103.

Memory unit 112 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

In some embodiments the memory unit 112 stores executable instructions that, when executed by processor 102, facilitate performance of operations of processor 102, as described herein.

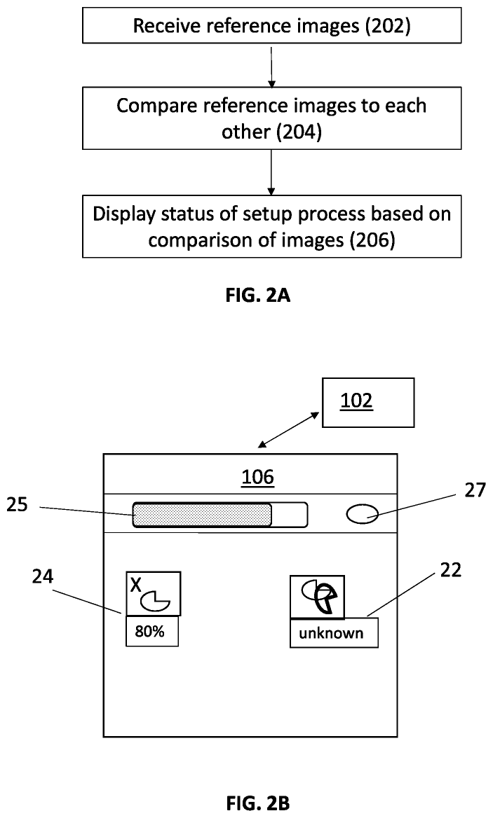

In one embodiment processor 102 carries out the process schematically illustrated in FIG. 2A. Processor 102 may receive a plurality of reference images, such as the set up images described above (step 202), each of the reference images including a same-type item 104 on an inspection line 105. Processor 102 then analyses the reference images, e.g., by comparing the reference images to each other (step 204) and, based on the analysis (e.g., comparison), determines a status of the visual inspection process (e.g., status of the set up stage of the visual inspection process) and may cause the status to be displayed to a user (step 206), e.g., on user interface device 106.

The status of a visual inspection process typically includes information based on the reference images. As schematically illustrated in FIG. 2B, the information may include data about positioning of an item on the inspection line, as determined from analysis of the reference images. Positioning of an item may include the locations and/or orientation of an item. For example, if a reference image includes an item at a new location and/or orientation on the inspection line, relative to earlier learned positions and/or orientations, the positioning of the item may be an “unknown positioning” and an unknown positioning status indication 22 may be displayed on a display of user interface device 106. In another example, if there are not enough reference images of the item at a specific positioning, status indication 22 may be displayed to indicate that more reference images showing the item at the specific positioning, are required. Alternatively or in addition, the information may include a “suspected defects” status, displayed on a display of user interface device 106 as indication 24, possibly with a probability indication (e.g., 80%) of the suspected defect being an actual defect. An indication of a “suspected defect” on a reference image (which, in one embodiment, should be defect-free) may be used to inform the user that the system does not identify the specific reference image as defect-free and that something in the image requires the user's attention.

In some embodiments, the status of the set up process may include information about the progress of the set up process, as determined from the set up images. In one example, the progress of the set up process may be represented by a graphical indication, e.g., progress bar 25, displayed on a display of user interface device 106. Thus, in one embodiment a visual inspection system includes a processor 102 to analyze images of items in a set up process. For example, analysis of images by the processor 102 may include comparison of images of the items in the set up process to each other, e.g., as detailed above. The processor is in communication with a user interface device 106, which includes a display showing progress of the set up process.

In some embodiments progress of the set up process may be determined based on the number of set up images available for analysis by the processor 102. In some embodiments, the user interface device 106 can accept user feedback regarding a set up image and the number of set up images used as reference images may change based on the user input. For example, a user may input feedback indicating that a set up image obtained during an initial set up stage or a reference image confirmed by a user in a set up stage occurring during the inspection stage, does not include a same-type item or that a set up image includes a defected item (in cases where the set up image should include only defect-free items). Based on this user input, the set up image (or other reference image) may be deleted from the reference image database and will no longer be available for analysis during the initial set up stage and/or whenever a new reference image is added to the reference database. In this case, the number of set up images available for analysis decreases and the display of user interface device 106 may thus show the progress of the set up process moving back, based on the user feedback. In other cases, each time a new set up image is received by processor 102 the display of user interface device 106 may show the progress of the set up process moving forward.

For example, the progress bar 25 may advance with each new set up image received for analysis and my regress when set up images are deleted, indicating to the user that more set up images should be supplied.

In one embodiment, a set up process may require inputting a predetermined number of set up images prior to advancing to the inspection stage. The progress of the set up process may be determined by the percentage of images received out of the predetermined number. In other embodiments, the number of set up images required may be dynamically determined by the processor 102, based on the analysis of each new received set up image. Thus, the progress of the set up stage may be dynamically determined by processor 102.

For example, a reference image showing an item at an unknown positioning may be displayed by processor 102 (e.g., with an unknown positioning status indication 22). The user may indicate (by inputting feedback via user interface device 106) that the positioning is correct and as a result, processor 102 may determine that additional reference images showing a same-type item at this positioning, are required for analysis. In this case, the graphical indication, e.g., progress bar 25, may regress to show that additional reference images are required.

In one embodiment user interface device 106 displays a button 27 to enable a user, e.g., by pressing the button, at any time point during the visual inspection process, to generate a request to display the reference images received up to that time point.

In some embodiments, upon pressing of button 27, the reference images can be displayed optionally with indications, e.g., an indication of a suspected defect (e.g., indication 24) and a probability of the suspected defect being an actual defect and/or an indication relating to positioning of the item.

The probability of a suspected defect being an actual defect can be calculated, for example, based its location within the image. A suspected defect located within a conservative area of the image (e.g., an area that does not change much in between images) may have a higher probability of being an actual defect than a suspected defect that is located within a less conservative area of the image. In some embodiments, machine learning algorithms used to detect a defect during inspection, may be used to calculate the probability of a suspected defect being an actual defect, e.g., based on defects learned during the inspection process.

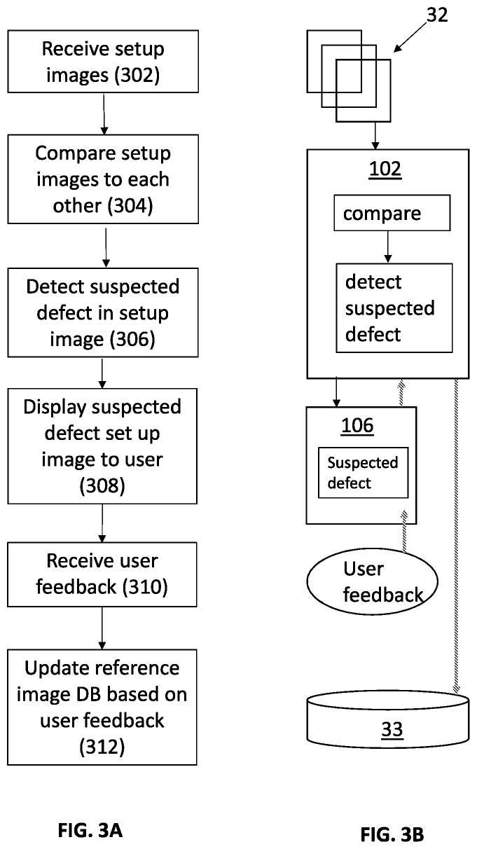

In one embodiment, which is schematically illustrated in FIGS. 3A and 3B, set up images 32 are received at processor 102 (step 302). The set up images are analyzed (step 304), e.g., by being compared to each other, as described above. A suspected defect may be detected on an item in one of the set up images based on the comparison (step 306). The set up image with the suspected defect is displayed to a user (step 308) for user feedback. User feedback is received (step 310) at processor 102 and a reference image database 33 is updated based on the user feedback (step 312). For example, as described above, an image may be deleted from the reference images database, based on user feedback. In another example, a set up image may be determined to include a defected item, based on user feedback, in which case the image may not be deleted but rather may be used to modify the analysis of the images by processor 102 and thereby update information regarding the reference images in the database 33.

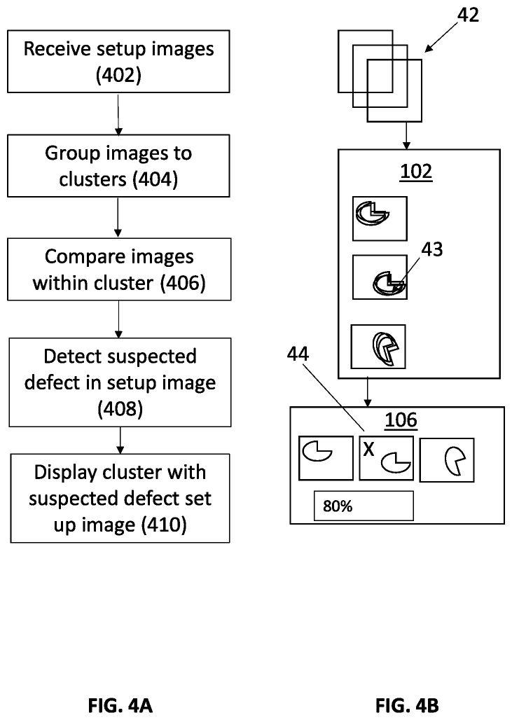

In one embodiment, which is schematically illustrated in FIGS. 4A and 4B, set up images 42 are received at processor 102 (step 402). Processor 102 groups the set up images into clusters according to a criterion (step 404) and compares the set up images in the cluster to each other (step 406). In some embodiments the clusters are displayed to the user for feedback.

A suspected defect 43 may be detected based on the comparison (step 408). The set up image with the suspected defect may then be displayed to a user (step 410) on user interface device 106, for user feedback. In some embodiments, the clusters are displayed to the user, with the cluster that includes the image with the suspected defect 43 being marked by indication 44. The clusters may be displayed to the user on user interface device 106, together with a probability indication of the suspected defect being an actual defect.

The criterion for clustering images together may include properties of the imaged items and/or properties of the images. For example, a criterion may be a visual feature of the imaged item. For example, one or more visible marks or patterns on an item may be used as a criterion for clustering images. Each cluster may include reference images having a high visual (appearance) resemblance, so that each of the images in the cluster can be used as a comparative reference to the others, without suffering from perspective distortion, which may reduce sensitivity.

In other examples a criterion may include a spatial feature of an item in the image, which effects the positioning of the item, e.g., a position or angle of placement of the object within the image (such as its position relative to the camera FOV, its rotation in three axes relative to the camera FOV, its shape or scale relative to the camera FOV, etc.). Each cluster may include reference images in which the item is similarly positioned. An image in which the item is not positioned similarly enough to other reference images, may require a user's attention to the differently positioned item.

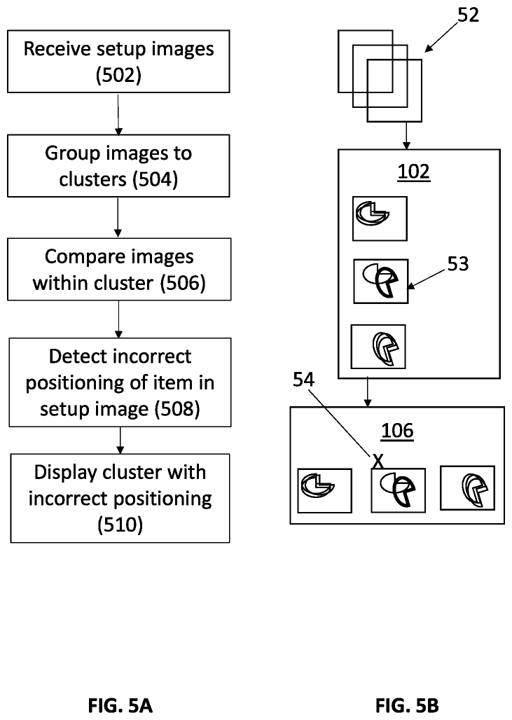

In one embodiment, which is schematically illustrated in FIGS. 5A and 5B, the set up images can be displayed, e.g., upon pressing of button 27, with an indication relating to positioning of the item on the inspection line.

In one embodiment, set up images 52 are received at processor 102 (step 502). Processor 102 groups the set up images into clusters according to a criterion (step 504), typically a criterion related to positioning of the item, and compares the set up images in the cluster to each other (step 506). In some embodiments the clusters are displayed to the user for feedback. The displayed clusters may include data about positioning of an item on the inspection line.

In one example, an unknown positioning of an item may be detected based on the comparison (step 508). The set up image with the unknown positioning 53 may then be displayed to a user (step 510) on user interface device 106, for user feedback. In some embodiments, the clusters are displayed to the user, with the cluster that includes the image with the unknown positioning 53 being marked by indication 54. As described above, a user may provide feedback regarding the positioning determined by processor 102 to be unknown, for example, the user may determine that the positioning of the item is correct or incorrect. The reference image database may be updated based on the user feedback. For example, a new cluster may be created for the unknown positioning determined to be correct based on the user's feedback.

In other embodiments, a cluster with not enough images of an item at a specific positioning may be displayed to the user and the user may provide feedback by adding more reference images of the item at the specific location.

In some embodiments, the user's feedback includes confirmation of a set up image. For example, a user may confirm a set up image by marking the borders of an item in a first set up image. Alternatively, a user may confirm a set up image by correcting borders of an item suggested by processor 102, in a first set up image. Other user inputs may be used to confirm that an image may be used as a reference image. For example, a user may confirm an image by pressing a button required for confirmation or by not pressing a button required for correcting an image, thereby confirming the image by default. Typically, all images of items obtained during a set up stage are user-confirmed, by default, because the user is requested to use only items fulfilling set up conditions (e.g., the items should be same-type items, the items should be defect-free, etc., as described above), during the set up stage.

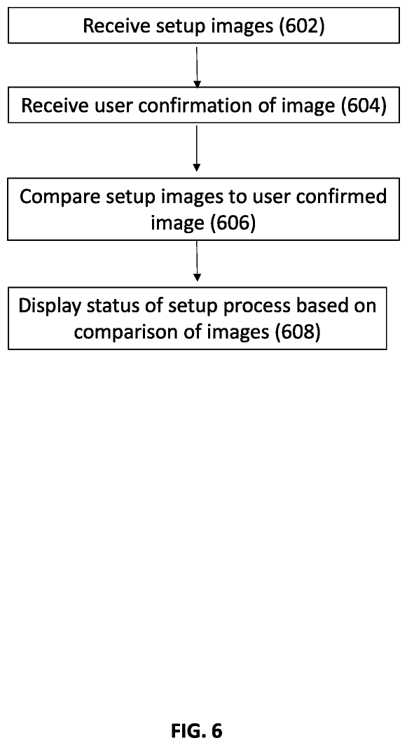

Once user confirmation is received on a first set up image, a second set up image may be compared to the first set up image to determine the status of the set up process. For example, as schematically illustrated in FIG. 6, set up images are received (step 602) at processor 102. User confirmation may be received on one of the images (step 604), e.g., via user interface device 106. At least one or more further set up images are compared to that image (step 606) and the status, typically, an updated status, of the set up process is determined and displayed based on the comparison of images (step 608).

Some embodiments of the invention provide an improved user interface for a visual inspection process.

In one embodiment, processor 102 causes a reference image to be displayed together with other reference images of the same-type item in a moving display, such as a Graphic Interchange Format (GIF) animation. In another embodiment processor 102 uses image differencing techniques to display a reference image with other reference images of the same-type.

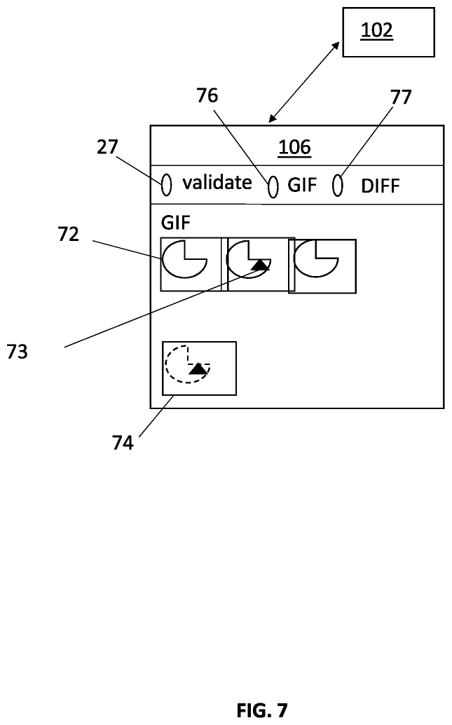

In one example, which is schematically illustrated in FIG. 7, a system for visual inspection includes a processor 102 in communication with a user interface device 106. The user interface device includes a display having a “validate” button 27, to enable a user to generate a request to display the reference images received up to that time point. For example, e.g., by pressing the button 27 at any time point during the set up stage and/or during the inspection stage (for example, if a user wishes to add a new reference image during the inspection stage), the received reference images may be displayed.

An animation button 76 and a DIFF button 77 enable the user assisted visualization of the reference images received at processor 102. In one embodiment, when pressing button 27 and button 76, an image of a defected (typically, a suspected defect) item 73 will be displayed together with images of defect-free items 72 in an animation, such as GIF, so that the user can more easily notice the defect. In one embodiment, images in an animation may be specifically arranged to amplify a suspected defect, e.g., the image with defected item 73 and images of defect free items 72 may be displayed alternatingly.

In another embodiment, when pressing button 27 and button 77, a difference image 74 of the reference images, or, typically of a suspected defect itself, will be displayed, so that the user can more easily locate the defect on the item.

Images displayed according to embodiments of the invention may be aligned or cropped or otherwise processed prior to being displayed as an animation and/or as a difference image, so as to better amplify a suspected defect.

In one embodiment, reference images can be grouped into clusters according to a criterion (e.g., as described above). A suspected defect can be detected on an item in one of the reference images and the set up image with the suspected defect on the item can then be displayed together with other reference images in the same cluster. The images of the same cluster may be displayed as an animation and/or as a difference image, as described above.

The user interface device 106 may include additional buttons, e.g., for hiding boarders or other occluding graphics and/or for zooming in, as described below.

In another embodiment, processor 102 may cause a heat map of positionings of the item in the plurality of reference images, as learned by processor 102, to be displayed.

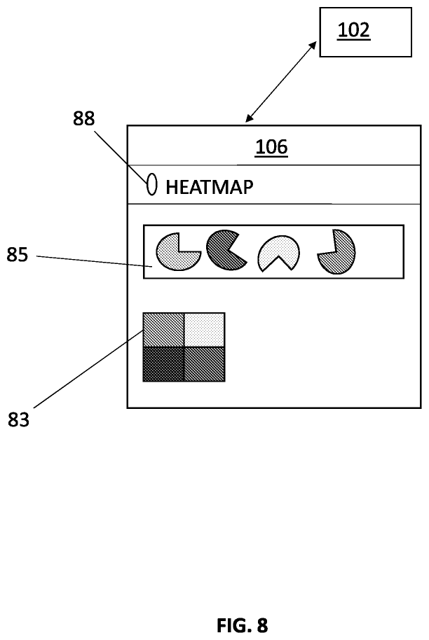

In one example, which is schematically illustrated in FIG. 8, a system for visual inspection includes a processor 102 in communication with a user interface device 106. The user interface device includes a display having a “heatmap” button 88.

In some embodiments processor 102 receives a plurality of reference images, each of the reference images including an item positioned on an inspection line. The processor 102 groups the reference images to clusters based on a positioning of the item on the inspection line and a graphical representation of positionings of items on the inspection line is displayed. The graphical representation may include a heat map. For example, a user can press button 88 to cause a heat map 85 of orientations of the item and/or a heat map 83 of locations of the object within the image, to be displayed. These ways of displaying reference images may assist the user in understanding issues related to positioning of items on the inspection line. For example, a user may see, based on presentation of a heat map of positionings that there are not enough images showing an item at a specific positioning

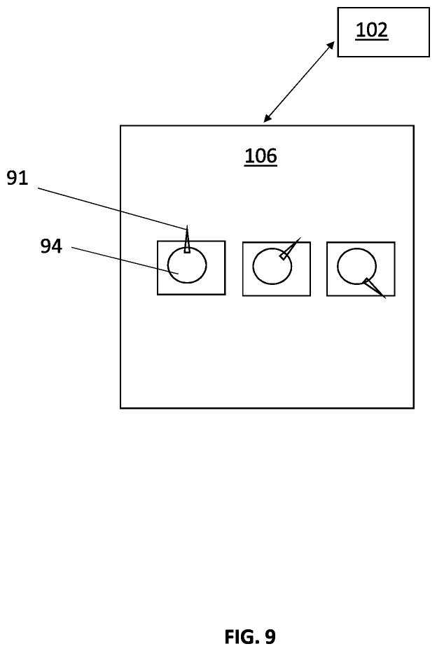

In one embodiment, which is schematically illustrated in FIG. 9, processor 102 may cause an orientation mark 91 to be displayed in an image (a reference image and/or an inspection image), on items 94 of symmetric shape.

In some embodiments, a symmetrically shaped item, such as item 94, may be first confirmed by a user, e.g., as described above, and the user my indicate an orientation of the item. For example, the user may mark and/or confirm the borders of the item in a set up image. The user may further mark, for example, the tip of the item when in an upright orientation. Processor 102 can then detect new items of the same type in new images and can mark the tip for all the new items relative to the confirmed borders of the item. Thus, when a symmetrically shaped item 94 is displayed, its tip as identified initially by a user, can be indicated by orientation mark 91 so that the user can understand the orientation of the item in each image.

In some embodiments, an item and/or an area of interest (e.g., an area of a suspected defect) on the item may be displayed with their boarders marked. The boarders may be determined automatically by processor 102, based on analysis of the reference images (e.g., as described above) and/or based on user confirmation, as described above. Processor 102 may cause the boarders and/or additional graphics to be superimposed on the images displayed on user interface device 106.

In some embodiments, an image with a suspected defect may be displayed (automatically or upon user request) without the boarders or other possibly occluding graphics.

Thus, in one embodiment, a visual inspection system may include a processor in communication with a user interface device. The processor analyzes images of items in a set up process and based on the analysis, detects a suspected defect in an area of the item in one of the images. The processor may then cause the image to be displayed with no graphics occluding the area of the suspected defect.

In some embodiments, an image with a suspected defect may be zoomed-in (automatically upon user request) on the item's boarders and/or on an area of interest (e.g., an area of the suspected defect) on the item.

Thus, in some embodiments, a visual inspection set up process includes receiving at a processor a plurality of reference images, each of the reference images including a same-type item on an inspection line. The processor may be used to compare the reference images to each other and to detect an area of a suspected defect in of one of the images, based on the comparison. The processor may then cause an enlargement of the detected area to be displayed. The enlargement of the detected area may be displayed in response to the user request received at the processor.

These ways of displaying reference images to a user assist the user in noticing a defect or other abnormalities on an item or in the image.

The visual inspection user interfaces according to embodiments of the invention enable a user to efficiently and quickly set up a visual inspection process for inspection tasks.

1. A visual inspection process comprising:
receiving a plurality of reference images, each of the reference images including a same-type item on an inspection line;
comparing the reference images to each other; and
displaying to a user a status of the process based on the comparison of the reference images to each other.

2. The process of claim 1 wherein the status comprises information based on the reference images.

3. The process of claim 2 wherein the information comprises suspected defects on an item in a reference image.

4. The process of claim 3 comprising:
detecting a suspected defect on the same-type item in one of the reference images, based on the comparison;
displaying to the user the reference image with the suspected defect, for user feedback; and
updating a reference image database based on the user feedback.

5-10. (canceled)

11. The process of claim 2 wherein the information comprises data about positioning of an item on the inspection line.

12. The process of claim 11 comprising:
detecting a positioning of an item on the inspection line, in a reference image, based on the comparison;
displaying to the user the reference image, for user feedback; and
updating a reference image database based on the user feedback.

13. The process of claim 2 wherein the information comprises progress of the visual inspection process based on a number of reference images received.

14. (canceled)

15. The process of claim 1 comprising
receiving a user request at a time point during the process; and
based on the user request, displaying to the user reference images received up to the time point.

16. The process of claim 15 comprising displaying a button on a user interface device, the button, if pressed by the user, to generate the user request.

17. The process of claim 15 comprising displaying the reference images with an indication of a suspected defect and a probability of the suspected defect being an actual defect.

18. The process of claim 15 comprising displaying the reference images with an indication of an unknown positioning.

19. The process of claim 1 comprising displaying a reference image with a suspected defect together with other reference images of the same-type item, as an animation.

20. (canceled)

21. The process of claim 1 comprising displaying a difference image of reference images.

22. The process of claim 1 comprising displaying a heat map of positioning of the item in the plurality of reference images.

23. The process of claim 1 comprising displaying an orientation mark on an item of symmetric shape, in an image.

24. A visual inspection system comprising
a processor to analyze reference images of items in a visual inspection process; and
a user interface device in communication with the processor, the user interface device comprising a display showing progress of the visual inspection process based on a number of reference images available for analysis by the processor.

25. The system of claim 24 wherein the processor compares the reference images to each other.

26. The system of claim 25 wherein the reference images consist of defect-free items and wherein the processor detects a suspected defect in of one of the reference images, based on the comparison, and causes an enlargement of an area of the suspected defect to be displayed.

27. The system of claim 26 wherein the processor causes display of the one of the reference images, with no graphics occluding the area of the suspected defect.

28. The system of claim 24 wherein the user interface is configured to accept user feedback regarding one or more of the reference images and wherein the display shows the progress moving forward or moving back based on the user feedback.
